(19) United States
(12) Patent Application Publication
(10) Pub. No.: US 2025/0265129 A1
(43) Pub. Date: Aug. 21, 2025

(54) LOAD BALANCING IN DISTRIBUTED SYSTEMS

(71) Applicant: Dell Products L.P., Round Rock, TX (US)

(72) Inventors: VINAY SAWAL, Fremont, CA (US); ALAN WHITE, Glasgow (GB); TSEHSIN JASON LIU, Wellesley, MA (US)

(21) Appl. No.: 18/443,752

(22) Filed: Feb. 16, 2024

(51) Int. Cl. G06F 9/50

(52) U.S. Cl. CPC G06F 9/5083; G06F 9/505; G06F 9/5072; G06F 2209/5019; G06F 2209/503

(57) ABSTRACT

Methods and systems for load balancing requests from clients across server devices are disclosed. The method may include obtaining a request from one of the clients. The method may also include making a determination regarding whether a load signature for the one of the clients is available. When the load signature for the one of the clients is available, one of the server devices may be selected based at least in part on the load signature and the selected one of the server devices may be assigned to service the request from the one of the clients.

### FIELD

Embodiments disclosed herein relate generally to load balancing requests from clients across server devices. More particularly, embodiments disclosed herein relate to load balancing connections between clients and servers using a computed load signature.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2B show data flow diagrams in accordance with an embodiment.

FIGS. 3A-3B show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for load balancing requests from clients across server devices. Clients may provide computer implemented services. To provide computer implemented services, clients may send requests to server devices. Server devices may share resources to fulfill the requests from many clients. Because the resources necessary to fulfill the requests from many clients may exceed the capacity of any one of server devices, the requests may be distributed across server devices by load balancing.

A load balancing system may select a server device to service a client request by considering current workloads of each of the server devices. However, workloads requested by the client may overload the selected server device at any point in time, causing interruptions/delays to the client requests being serviced, which may negatively impact the computer implemented services provided by the client.

To reduce a likelihood that a selected server device may be overloaded by a client request, a load signature for the client may be utilized. The load signature may be a prediction of the workload requirements of the client. The load signature may be available if any server devices has serviced a previous request by the client. While the previous request is being serviced, connection data (e.g., bandwidth, data transfer, connection quality, etc.) may be recorded and stored. The connection data may be processed (e.g., cleaned, decomposed, etc.) to obtain inference ready data, one or more inference models may be used to obtain corresponding forecasts, and meta-learning may be performed to obtain the load signature for the client.

Thus, embodiments disclosed herein may provide an improved method for load balancing requests from clients by taking into account both the current load state of devices that may service the client requests as well as the likely future load that new requests may place on the devices.

In an embodiment, a method for load balancing requests from clients across server devices is provided. The method may include (i) obtaining a request from one of the clients; (ii) making a determination regarding whether a load signature for the one of the clients is available; and (iii) in a first instance of the determination where the load signature for the one of the clients is available: (a) selecting one of the server devices based at least in part on the load signature; and (b) assigning the selected one of the server devices to service the request from the one of the clients.

The method may further include, prior to obtaining the request, (i) obtaining connection data for use of a connection between the one of the clients and any of the server devices for a period of time; (ii) processing the connection data to obtain inference ready connection data; (iii) obtaining, using a plurality of inference model and the inference ready connection data, a plurality of forecasts for future use of the connection by the one of the client; and (iv) performing meta-learning on the plurality of forecasts to obtain the load signature.

Obtaining the connection data may include (i) servicing, by any of the server devices, a previous request from the one of the clients; and (ii) while the previous request is being serviced by the one of the client, recording the connection data.

Obtaining the connection data may also include storing the connection data in a data structure to extend a time series of connection data for the one of the clients.

Processing the connection data to obtain the inference ready connection data may include (i) cleaning the connection data to remove any artifacts from the connection data; and (ii) decomposing the connection data into a plurality of characteristics of past use of a connection by the one of the client devices.

The characteristics may include (1) bandwidth, (ii) data transfer, and (iii) connection quality.

Processing the connection data to obtain the inference ready connection data may also include, for a characteristic of the characteristics: identifying a level of seasonality, trends, and events.

Performing the meta-learning on the plurality of forecasts to obtain the load signature may include (i) identifying a level of quality of each of the plurality of forecasts; and (ii) using the level of quality and the plurality of forecasts to obtain the load signature.

Making a determination may include performing a lookup in a load signature database using an identity of the client as a key to obtain a lookup result that indicates whether the load signature is available.

Selecting the one of the server devices based at least in part on the load signature may include (i) identifying utilization rates of the server devices; (ii) comparing the utilization rates to the load signature to identify whether assignment of the request to each server device is likely to overload the server device; and (iii) selecting any of the server devices that are likely to not be overloaded as the one of the server device.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

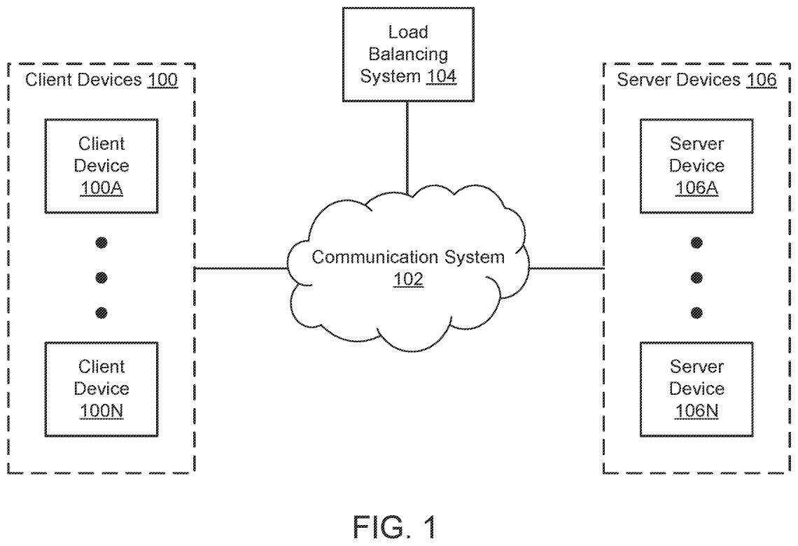

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, the system of FIG. 1 may include client devices 100, load balancing system 104, and server devices 106. The computer implemented services may be provided by one or more components of the system of FIG. 1. For example, a client device (e.g., 100A) of client devices 100 may provide at least a portion of the computer implemented services using data obtained from server devices 106. Client devices 100 may include any number of client devices that may each utilize data from server devices 106. Because the resources necessary to fulfill the requests from many client devices 100 may exceed the capacity of any one of server devices 106, the requests may be distributed across server devices 106. To facilitate distribution of the requests, server devices 106 may utilize connection distributing services provided by load balancing system 104.

To distribute the connection requests, load balancing system 104 may employ a load balancing algorithm. A load balancing algorithm aims to distribute the load so that any one of server devices 106 may not be overloaded. The load may be the cumulative computational work required to service requests from client devices 100. To improve the likelihood of successful load balancing, the load balancing algorithm may consider current status (e.g., response time, number of connections, availability of resources, etc.) of the server devices 106 when assigning connection from client devices 100.

However, the load may become unevenly distributed when the computational load requirements of client devices 100 become misaligned with the resource availability of a connected server device of server devices 106. Misalignment may occur, for example, due to an increase in the number of client devices 106 that the server device (106A) is responsible for servicing, due to an increase in a volume of requests from one or more of client devices 106 that server device 106A is responsible for servicing, etc. If the computational load exceeds the resources available to the selected one of server devices 106, the computer implemented services provided by the system of FIG. 1 may be impacted. For example, if server devices 106 are unable to process the requests from client devices 100 due to resource constraints, then the rate at which the components of FIG. 1 may be able to provide computer implemented services may be reduced.

In general, embodiments disclosed here relate to systems and methods for load balancing requests from client devices across server devices. To load balance requests from client devices, a load balancing system may be utilized. The load balancing system may obtain a request from one of the client devices and perform an action set based on the availability of a load signature for the one of the client devices. If the load signature is determined to be available, the load balancing system may select one of the server devices to service the client request based at least in part on the information provided by the load signature. Thus, a likelihood that the computational load requirements of the client device may overload the resource availability of a server device may be decreased.

When a request from a client device is received, the load balancing system may determine if a load signature is available for the client device. To do so, the load balancing system may perform a query on a load signature database using an identity of the client device (e.g., client ID, IP address, etc.) as a key to obtain a result that indicates whether a load signature is available. If a load signature is not available, the load balancing system may proceed to select a server device to service the request based on a conventional load balancing algorithm (e.g., round robin, least loaded, etc.). However, if a load signature is available, the load balancing system may perform a comparison process using the load signature of the client device and utilization rate of a server device to determine whether selection of the server device may be likely to overload the server device.

Performing the comparison process may include obtaining, by the load balancing system, the load signature for the client device, the utilization rate for the server device; and making a determination, based on the load signature of the client device and the utilization rate of the server device, whether a connection between the client device and the server device may be likely to overload the resource availability of the server device.

A load signature may be a prediction of the computational load requirements of a client device. The prediction may be generated by an ensemble learning model. The ensemble learning model may include any number or types of individual learning models, and may be modified to improve predictive capabilities of the load signature. The ensemble learning model may output the load signature as a single prediction of the load characteristics of a client device. To output a single prediction, a prediction combining process may be performed on a plurality of predictions generated by respective individual learning models. The prediction combining process may be a meta-learning algorithm (e.g., stacking, bagging, boosting, etc.) that may evaluate the level of quality of predictions made by each of learning models. Each of the learning models may make a prediction inferred from connection data prepared to be inference ready.

To prepare the connection data to be inference ready, the load balancing system may perform a data decomposing process. Performing the data decomposing process may include cleaning the connection data, and decomposing the connection data into a plurality of characteristics, for example, seasonality, trends, events, etc.

Connection data may be obtained from a previous connection between a client device and one of the server devices. To obtain the connection data, connection metrics (e.g., bandwidth, data transfer, connection quality, etc.) may be recorded and stored in a data structure.

A data structure may be, for example, a time series database that may store connection data for client devices over a period of time. The time series data for a client device may be extended when additional connection data is obtained from additional client requests being serviced by server devices.

By utilizing the load balancing approach discussed above, requests from clients may be more likely to be timely serviced (e.g., in accordance with service level agreements) by taking into account both the current load state of devices that may service the client requests as well as the likely future load that new requests may place on the devices.

To provide the above noted functionality, the system may include client devices 100, load balancing system 104, server devices 106, and communication system 102. Each of these components is discussed below.

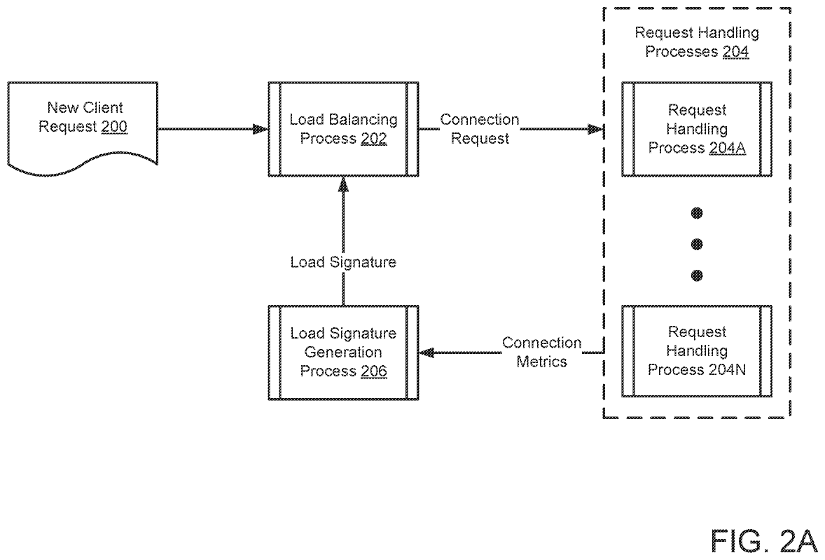

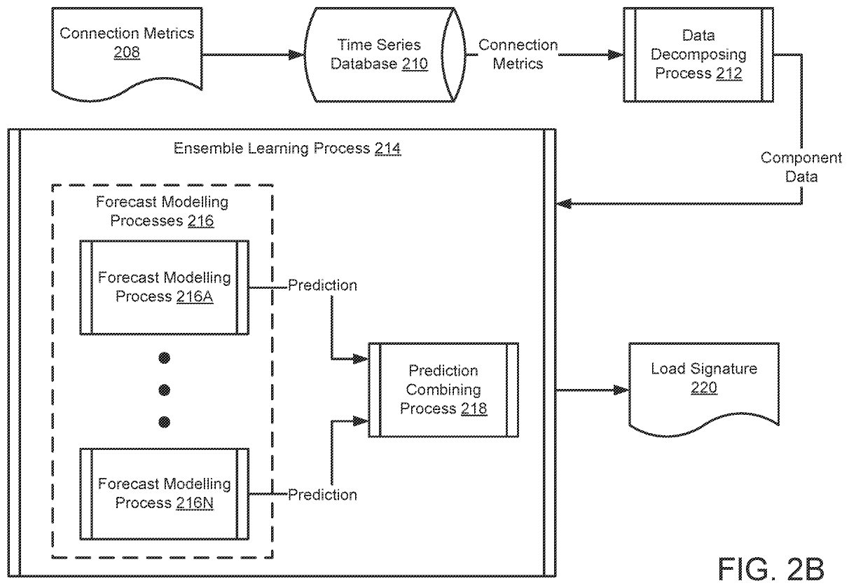

Client devices 100 may, as discussed above, provide various computer implemented services to users thereof and/or other devices operably connected to client devices. To provide the computer implemented services, client devices 100 may utilize the functionality of server device 106. To do so, client devices 100 may send requests for various workloads to be performed. Refer to FIGS. 2A-2B for additional details regarding operation of client devices 100 and use of services provided by server devices 106 by client devices 100.

Load balancing system 104 may, as discussed above, provide load balancing services. To provide the load balancing services, load balancing system 104 may obtain the client requests from client devices 100, identify server devices that are able to handle the client requests, and distribute the client requests to the identified server devices. To identify the server devices that are able to handle the client requests, the load balancing system may take into account both the current workloads of the server devices as well as the predicted workloads of the client devices. Refer to FIGS. 2A-2B for additional details regarding load balancing services provided by load balancing system 104.

Server devices 106 may, as discussed above, provide request handling services for requests obtained from client devices 100. To provide the request handling services, server devices 106 may obtain client assignment from load balancing system 102, and perform workloads requested by client devices 100. Refer to FIGS. 2A-2B for additional details regarding request handling services provided by server devices 106.

Communication system 102 may allow any of client devices 100, load balancing system 102, and server devices 106 to communicate with one another (and/or with other devices not illustrated in FIG. 1A). To provide its functionality, communication system 102 may be implemented with one or more wired and/or wireless networks. Any of these networks may be a private network (e.g., the “Network” shown in FIG. 6), a public network, and/or may include the Internet. For example, client devices 100 may be operably connected to server devices 106 via the Internet. Client devices 100, load balancing system 102, server devices 106 and/or communication system 102 may be adapted to perform one or more protocols for communicating via communication system 102.

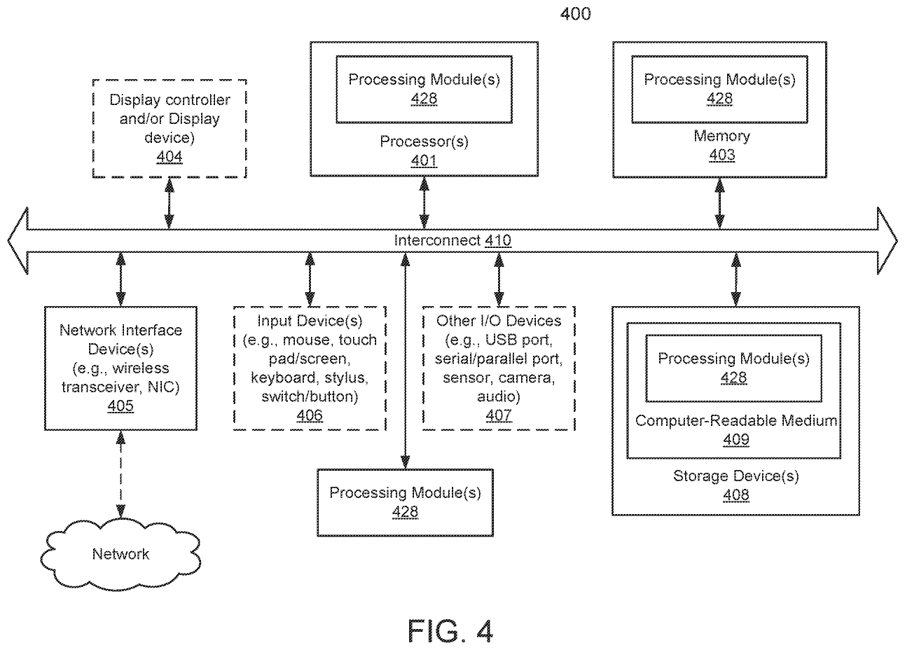

Any of (and/or components thereof) client devices 100, load balancing system 104, and server devices 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1, a system in accordance with an embodiment may load balance requests from client devices 102 across server devices 106 using at least in part predictive information provided by a load signature.

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 200, 208, etc.) is used to represent data structures, a second set of shapes (e.g., 202, 204, etc.) is used to represent processes performed using and/or that generate data, and a third set of shapes (e.g., 210, etc.) is used to represent large scale data structures such as databases.

Turning to FIG. 2A, a first data flow diagram in accordance with an embodiment is shown. The first data flow diagram may illustrate data used in and data processing performed in improving a likelihood that a client request may be serviced in a timely manner by server devices.

To improve a likelihood that a client request may be serviced timely, load balancing process 202 may be performed. During load balancing process 202, new client request 200 may be obtained from a client device, the client request may be processed, and a server device may be assigned. New client request 200 may include any type and quantity of information regarding (i) requests for a workload to be performed by a server device, (ii) information regarding the identity of the client device, and/or other types of information usable to facilitate completion of requests. For example, a client device may send a new client request for a server device to retrieve a requested type of data, for a requested period of time, etc.

New client request 200 may be used in load balancing process 202 to identify client information, and request handling processes 204 to provide information on workload to be performed by a server device. Once obtained from a client device, new client request 200 may be processed by load balancing process 202.

To process client request 200, the client information from client request 200 may be used to perform a lookup to obtain a lookup result that indicates whether a load signature is available. For example, a load signature database may be queried using the identity of the client as a key. A load signature may include any type and quantity of information regarding a prediction of future workload characteristics of the client. A load signature may include, for example, predictions for various workload metrics (e.g., bandwidth, data transfer, connection quality, time, etc.) that may be expected while servicing future requests for the client. When generated, load signature may be indexed, associated with clients, and/or otherwise placed in condition for use in lookups.

To assign a server device to service new client request 200, one of server devices 106 may be selected to send the client request based on any number of available information (e.g., load signature, server load utilization, etc.). If a load signature is determined to be available for the client, the predicted workload information provided by the load signature may be compared to the workload capacity of a server device when assigning one of server devices 106 to service the client request.

For example, a load signature for a client may indicate that the client may utilize a range of 20 percent to 35 percent of total server bandwidth over a period of 30 days. In this example, server devices 106A-106N may be available to receive assignment of new client requests and have a maximum load utilization of 100 percent. If server device 106A has a load utilization rate of 60 percent and server devices 106B-106N have load utilization rates of 70-80 percent, load balancing process 202 may assign the server device 106A to service the client request due to consideration that server device 106A may be able to service the client request without exceeding the available load utilization rates. If the client utilization exceeds the available server load utilization on the assigned server, the server device may overload (e.g., computing resource demand exceeding available resources) and the client request may need to wait for server utilization to decrease before completing the client request. By not overloading the server device, the likelihood that the client request will be serviced timely may be increased.

Otherwise, if a load signature is determined to not be available for the client, a different load balancing algorithm (e.g., round robin, least loaded, etc.) may be used when assigning one of server devices 106 to service the client request. These different load balancing algorithms may not take into account the future workload that is likely to be imposed by the client request.

Once a client request is assigned for servicing, request handling services 204 may be performed. During request handling services 204, workloads may be performed using server resources, responses may be provided, connection metrics may be collected, and/or other actions may be performed. To perform the workloads, a connection may be formed between the client and the assigned server. While the connection is in place, actions specified by client request 200 may be processed and distributed to one or more computing resources hosted by a server device that may be able to perform the action. For example, a client request to retrieve data may be obtained by a server device, processed by the server CPU, read in the server storage and memory, and communicated by the server network resources. To provide a response, a message may be sent to communicate the results of the requested workload. The message may comprise, for example, a confirmation that the requested workload was performed or requested information.

While performing request handling processes 204, connection metrics may be collected. To collect the connection metrics, characteristics of the connection between the client and server (e.g., time, bandwidth, data transfer, etc.) may be recorded over a period of time and stored. When request handling processes 204 are complete, the connection between client and server may close.

Once obtained, the connection metrics may be used during load signature generation process 206 to obtain load signatures. Refer to FIG. 2B for additional information regarding load signature generation process 206. The result of load signature generation process 206 may be a load signature for the connected client.

A load signature may be stored and provided to a future instance of load balancing process 202. Because the same client may attempt to send another new client request, in the next instance of new client request 200 from the same client, a load signature may be available to be used by load balancing process 202. If a load signature is used by load balancing process 202, a likelihood that request handling process 204 may be performed timely may be increased. Additionally, the load signature may be updated for the client by extending the connection metrics time series data during the next iteration of request handling processes and load generation process. The updated load signature may provide more accurate information for future load balancing processes for the same client.

Thus, using the data flows shown in FIG. 2A, a likelihood that a client request may be serviced timely may be improved by using a client load signature in a load balancing process to assign a server device to service the client request that may be less likely to overload the selected server device.

Turning to FIG. 2B, a second data flow diagram in accordance with an embodiment is shown. The second data flow diagram may illustrate data used in and data processing performed in generating a load signature for a client device.

To generate a load signature, data decomposing process 212 may be performed to prepare the data to be inference ready. During data decomposing process 212, connection metrics 208 may be obtained, cleaned, decomposed, and/or other actions may be performed. Connection metrics 208 may include any type and quantity of information regarding workload measurements collected during request handling processes 204. Connection metrics 208 may be stored in time series database 210. To store connection metrics 208 in times series database 210, a data structure may be (i) created with times series data from connection metrics 208, (ii) updated with additional data points of the times series, and/or any other actions to store time series data in times series database 210.

Connection metrics 208 may be organized as, for example, a table including rows corresponding to workload measured at a point in time. Connection metrics 208 may be organized differently (e.g., as a linked list, unstructured data, etc.) without departing from embodiments disclosed herein. In an example in which connection metrics 208 are organized as a table, each row may include information regarding a connection metric variable, for example, bandwidth, data transfer, and connection quality data, etc. Further, the rows may be keyed to facilitate efficient searching based on an identity of clients, for example, client identifiers. Connection metrics 208 may be used in data decomposing process 212 to identify characteristics within the data.

Connection metrics 208 may be obtained by reading from time series database 210. Once obtained connection metrics 208 may be cleaned to remove or resolve undesirable artifacts from the time series data. For example, irrelevant data, duplicate data, and outliers may be removed from the data, missing data may be removed or imputed, and/or other types of modifications may be made to address any type and quantity of data quality criteria/expectations.

The cleaned data may be decomposed to obtain component data. To decompose the time series data, a time series decomposition technique may be used, for example, additive decomposition, multiplicative decomposition, moving averages, etc. The resulting component data (e.g., trend, seasonality, events, etc.) may be used to improve accuracy of a forecast modelling process.

The component data may be ingested by ensemble learning process 214. During ensemble learning process 214, the component data may be subjected to any number of forecast modelling processes 216 for inferencing and combined to form a single prediction. During one of forecast modelling processes 216, a forecast model may be selected, component data may be used to train a forecast model, and a prediction may be generated. To select a forecast model, characteristics of the data may be considered, for example, size of data set, complexity of data, etc.

To train the selected forecast model, a supervised or unsupervised learning approach may be used. For a supervised learning approach, a model may generate a predictive equation based on a desired outcome. For example, a sample of component data may be used as an input to the forecast model, a prediction may be generated, results of the prediction may be compared to the desired results, and the process may be repeated to obtain a predictive equation. For an unsupervised learning approach, a predictive equation may be generated by identifying patterns in the component data without comparing to desired results.

A predictive equation may be used to generate a prediction for a desired future period. Each of forecast modelling processes 216A-216N may generate a prediction for workload requirements over a period of time for the client device.

To combine the predictions generated by each of forecast modelling processes 216-216N, prediction combining process 218 may be performed. During prediction combining process 218, a meta-learning technique may be applied to each of and/or on the totality of predictions generated by forecast modelling process 216 to output a load signature for the client. For example, the predictions may be combined by (i) averaging the predictions, (ii) assigning weights to the predictions, (iii) voting by the predictions, and/or other techniques usable to combine different predictions.

Load signature 200 may include any type and quantity of information regarding a prediction of the workload characteristics of the client. Load signature 200 may include, for example, predictions for various connection metrics (e.g., bandwidth, data transfer, connection quality, etc.) expected to service a client request. The predictions may be time series for the connection metrics over a future period of time.

Load signature 200 may be used in load balancing process 202 to select server devices to assign client requests.

Thus, using the data flows shown in FIG. 2B, load signature may be generated, indicating a prediction of workload requirements for a client.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

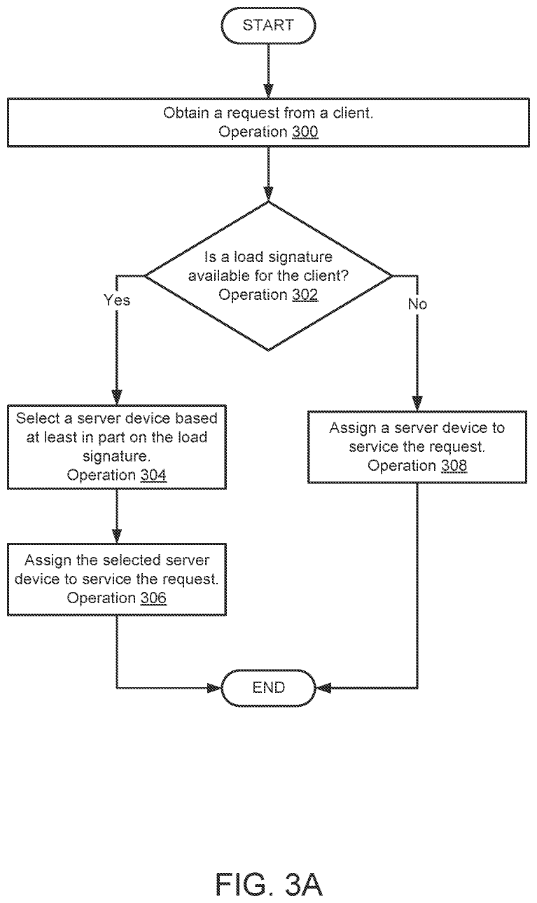

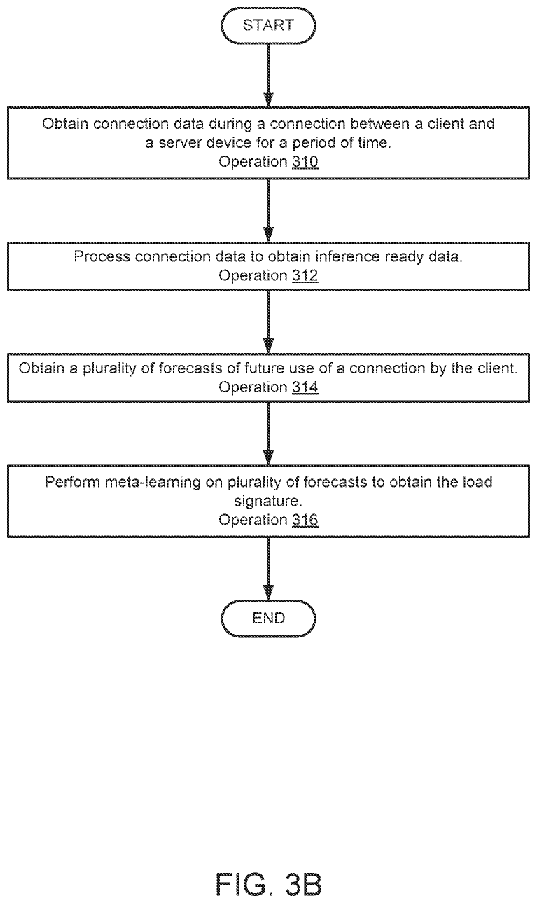

As discussed above, the components of FIG. 1 may perform various methods to load balance requests from clients across server devices. FIGS. 3A-3B illustrate methods that may be performed by the components of the system of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method of load balancing requests from clients across server devices in accordance with an embodiment is shown. The method may be performed, for example, by any of the components of the system of FIG. 1, and/or other components not shown therein.

Prior to operation 300, a load signature for a client may be obtained. The load signature may be obtained by (i) obtaining connection data during a previous connection between a client and a server device for a period of time, (ii) processing the connection data, (iii) obtaining a plurality of forecasts, (iv) performing meta-learning on the plurality of forecasts, and/or performing any other actions. Refer to FIG. 3B for additional information.

At operation 300, the client request may be obtained from a client that indicates a request is to be serviced by a server device. The client request may be obtained by (i) receiving a request sent by a client device, (ii) receiving a request from a processing queue, and/or any other method.

At operation 302, a determination may be made regarding whether a load signature is available for the client. The determination may be made by (i) obtaining information from the client request, (ii) performing a lookup using an identity of the client as a key, (iii) obtaining a lookup result that indicates whether the load signature is available, and/or any other actions. If the load signature is available (e.g., the determination is “Yes” at operation 302), then the method may proceed to operation 304. If the load signature is determined to be not available (e.g., the determination is “No” at operation 302), then the method may proceed to operation 308.

At operation 304, a server device may be selected based at least in part on the load signature. The server device may be selected by (i) identifying utilization rates of the server devices, (ii) comparing the utilization rates to the load signature, (iii) identifying whether assignment of the request to each server device is likely to overload the server device, (iv) selecting any of the server devices that are not likely to be overloaded, and/or any other methods.

At operation 306, the selected server device may be assigned to service the request. The selected server device may be assigned by (i) initiating opening of a connection between the client and server, (ii) facilitating sending of the request to the selected server device, and/or any other methods.

The method may end following operation 306.

Returning to operation 302, the method may proceed to operation 308 following operation 302 when a load signature for the client is unavailable.

At operation 308, a server device may be assigned to service the request. The service device may be assigned to service the request by (i) selecting one of the server devices as the server device base on a selection algorithm, and (ii) assigning the selected one of the server devices to service the workload by transmitting connection information to the client for the server device. The selection algorithm may be based on (i) a rotation (e.g., round robin), (ii) amount of open connections on the server (e.g., least connection), and/or any other algorithm/method usable to distribute client requests.

The method may end following operation 308.

Using the method shown in FIG. 3A, the likelihood of client requests being serviced timely may be improved by using load signatures in making assignment decisions. The use of load signatures may allow the assignment process to take into account likely future workloads imposed on server devices by the clients issuing the client requests.

Turning to FIG. 3B, a second flow diagram illustrating a method of obtaining a load signature in accordance with an embodiment is shown. The method may be performed, for example, by any of the components of the system of FIG. 1, and/or other components not shown therein.

At operation 310, connection data may be obtained during a connection between a client and a server device for a period of time. The connection data may be obtained by (i) monitoring characteristics of the connection (e.g., bandwidth, data transfer, connection quality, etc.) over a period of time, (ii) recording the connection data, (iii) storing the connection data in a data structure, and/or any other methods. The connection data may be stored by initializing a data structure, extending an existing data structure, and/or via other methods.

At operation 312, the connection data may be processed to obtain inference ready data. The connection data may be processed by (i) cleaning the connection data to remove any artifacts from the connection data, (ii) decomposing the connection data into a plurality of characteristics, and/or any other processes to obtain inference ready data. For example, to clean the connection data: (i) irrelevant data, duplicate data, and outliers may be removed, (ii) missing data may be removed or imputed, and/or other types of modifications may be made to address any type and quantity of data quality criteria/expectations. To decompose the connection data, for a characteristic of the characteristics, a level of seasonality, trends, and/or events may be identified. For example, seasonality may be patterns in the data that occur at/during (i) holiday periods, (ii) times of year, and/or any other periods of time. Trends may be (i) increasing, (ii) decreasing, and/or any other directional patterns that the data may exhibit. Events may be (i) sales events, (ii) sports events, and/or any other specific occurrence that may affect patterns in the data.

At operation 314, a plurality of forecasts for future use of the connection by the client may be obtained. The plurality of forecasts may be obtained by (i) ingesting the inference ready connection data into the plurality of inference models to obtain corresponding predictions, (ii) aggregating the corresponding predictions as the plurality of forecasts, and/or via other methods. To train an inference model, (i) training data (e.g., labeled training data) may be prepared from time series data, (ii) a model may be selected based on qualities of the training data, (iii) the model may be tested to evaluate performance, (iv) parameters (e.g., weights) may be adjusted, and/or any other methods may be used.

At operation 316, meta-learning may be performed on the plurality of forecasts to obtain the load signature. To obtain the load signature, (i) a level of quality of each of the forecasts may be considered (e.g., weight), (ii) the forecasts may be combined (e.g., weighted sum) based on the considered levels of quality, and/or any other methods of aggregation may be applied. The level of quality of each of the forecasts may be identified. For example, to identify a level of quality of a forecast, (i) predictive capabilities of the inference models may be quantified during and/or after training of the inference model, (ii) accuracy of the inference models for the ingested inference ready training data may be computed, (iii) any other criteria may be considered in ascertaining the accuracies of the predictions provided by the inference models, and/or other methods may be used.

The method may end following operation 316.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for load balancing requests from clients across server devices, the method comprising:
obtaining a request from one of the clients;
making a determination regarding whether a load signature for the one of the clients is available;
in a first instance of the determination where the load signature for the one of the clients is available:
selecting one of the server devices based at least in part on the load signature;
assigning the selected one of the server devices to service the request from the one of the clients.

2. The method of claim 1, further comprising:
prior to obtaining the request:
obtaining connection data for use of a connection between the one of the clients and any of the server devices for a period of time;
processing the connection data to obtain inference ready connection data;
obtaining, using a plurality of inference model and the inference ready connection data, a plurality of forecasts for future use of the connection by the one of the client; and
performing meta-learning on the plurality of forecasts to obtain the load signature.

3. The method of claim 1, wherein obtaining the connection data comprises:
servicing, by any of the server devices, a previous request from the one of the clients; and
while the previous request is being serviced by the one of the client, recording the connection data.

4. The method of claim 3, further comprising:
storing the connection data in a data structure to extend a time series of connection data for the one of the clients.

5. The method of claim 2, wherein processing the connection data to obtain the inference ready connection data comprises:
cleaning the connection data to remove any artifacts from the connection data; and
decomposing the connection data into a plurality of characteristics of past use of a connection by the one of the client devices.

6. The method of claim 5, wherein the characteristics comprise:
bandwidth;
data transfer; and
connection quality.

7. The method of claim 5, wherein processing the connection data to obtain the inference ready connection data further comprises:
for a characteristic of the characteristics:
identifying a level of seasonality, trends, and events.

8. The method of claim 2, wherein performing the meta-learning on the plurality of forecasts to obtain the load signature comprises:
identifying a level of quality of each of the plurality of forecasts; and
using the level of quality and the plurality of forecasts to obtain the load signature.

9. The method of claim 1, wherein making a determination comprises:
performing a lookup in a load signature database using an identity of the client as a key to obtain a lookup result that indicates whether the load signature is available.

10. The method of claim 1, wherein selecting the one of the server devices based at least in part on the load signature comprises:
identifying utilization rates of the server devices;
comparing the utilization rates to the load signature to identify whether assignment of the request to each server device is likely to overload the server device; and
selecting any of the server devices that are likely to not be overloaded as the one of the server device.

11. A non-transitory machine-readable medium having instructions stored therein, which when executed by a processor, cause the processor to perform operations for load balancing requests from clients across server devices, the operation comprising:
obtaining a request from one of the clients;
making a determination regarding whether a load signature for the one of the clients is available;
in a first instance of the determination where the load signature for the one of the clients is available:
selecting one of the server devices based at least in part on the load signature;
assigning the selected one of the server devices to service the request from the one of the clients.

12. The non-transitory machine-readable medium of claim 11, wherein the operation further comprise:
prior to obtaining the request:
obtaining connection data for use of a connection between the one of the clients and any of the server devices for a period of time;
processing the connection data to obtain inference ready connection data;
obtaining, using a plurality of inference model and the inference ready connection data, a plurality of forecasts for future use of the connection by the one of the client; and
performing meta-learning on the plurality of forecasts to obtain the load signature.

13. The non-transitory machine-readable medium of claim 11, wherein obtaining the connection data comprises:
servicing, by any of the server devices, a previous request from the one of the clients; and
while the previous request is being serviced by the one of the client, recording the connection data.

14. The non-transitory machine-readable medium of claim 3, wherein the operation further comprise:
storing the connection data in a data structure to extend a time series of connection data for the one of the clients.

15. The non-transitory machine-readable medium of claim 12, wherein processing the connection data to obtain the inference ready connection data comprises:
cleaning the connection data to remove any artifacts from the connection data; and
decomposing the connection data into a plurality of characteristics of past use of a connection by the one of the client devices.

16. A data processing system, comprising:
a processor; and
a memory coupled to the processor to store instructions, which when executed by the processor, cause the processor to perform operations for load balancing requests from clients across server devices, the operations comprising:
obtaining a request from one of the clients;
making a determination regarding whether a load signature for the one of the clients is available;
in a first instance of the determination where the load signature for the one of the clients is available:
selecting one of the server devices based at least in part on the load signature;
assigning the selected one of the server devices to service the request from the one of the clients.

17. The data processing system of claim 16, wherein the operation further comprise:
prior to obtaining the request:
obtaining connection data for of use a connection between the one of the clients and any of the server devices for a period of time;
processing the connection data to obtain inference ready connection data;
obtaining, using a plurality of inference model and the inference ready connection data, a plurality of forecasts for future use of the connection by the one of the client; and
performing meta-learning on the plurality of forecasts to obtain the load signature.

18. The data processing system of claim 16, wherein obtaining the connection data comprises:
servicing, by any of the server devices, a previous request from the one of the clients; and
while the previous request is being serviced by the one of the client, recording the connection data.

19. The data processing system of claim 17, wherein the operation further comprise:
storing the connection data in a data structure to extend a time series of connection data for the one of the clients.

20. The data processing system of claim 19, wherein processing the connection data to obtain the inference ready connection data comprises:
cleaning the connection data to remove any artifacts from the connection data; and
decomposing the connection data into a plurality of characteristics of past use of a connection by the one of the client devices.
